(19) United States
(12) Patent Application Publication
(10) Pub. No.: US 2026/0007297 A1
(43) Pub. Date: Jan. 8, 2026

(54) Dual Cleaning Head Device

(71) Applicant: Martine Jabouin, Hillsdale, NJ (US)

(72) Inventor: Martine Jabouin, Hillsdale, NJ (US)

(21) Appl. No.: 19/246,897

(22) Filed: Jun. 24, 2025

Related U.S. Application Data
(60) Provisional application No. 63/666,711, filed on Jul. 2, 2024.

(51) Int. Cl. A47L 13/22; B25G 1/04

(52) U.S. Cl. CPC A47L 13/22; B25G 1/04

(57) ABSTRACT

A dual cleaning head device is provided. The device is comprised of a body having a dual-sided cleaning head assembly, a spray mechanism, and a fluid reservoir system comprising at least two separate containers for cleaning solutions. A selector valve enables users to draw from one container, the other, or a mixture of both, directing the fluid to at least one spray mechanism with a nozzle and flow regulator. The cleaning head assembly is pivotally attached to the body and includes a first side comprising a mop element and a second side comprising a scrubbing element, both of which are removably attached for ease of maintenance. The device further comprises at least one trigger to control fluid spray and permits manual rotation of the cleaning head to alternate between mop and scrubbing functions during operation.

### CROSS-REFERENCE TO RELATED APPLICATION

The present application claims priority to, and the benefit of, U.S. Provisional Application No. 63/666,711, which was filed on Jul. 2, 2024, and is incorporated herein by reference in its entirety.

### FIELD OF THE INVENTION

The present invention relates generally to the field of cleaning devices. More specifically, the present invention relates to a dual-head cleaning device capable of spraying multiple different cleaning solutions. Accordingly, the present disclosure makes specific reference thereto. Nonetheless, it is to be appreciated that aspects of the present invention are also equally applicable to other like applications, devices, and methods of manufacture.

### BACKGROUND

The process of cleaning hard floor surfaces such as hardwood and vinyl often presents challenges that are not easily resolved with conventional cleaning tools. Users typically require a range of equipment including mops, abrasive scrubbers, and multiple types of cleaning solutions in order to address surface stains, residue, and embedded debris. This fragmented approach not only increases the time and effort required to clean but also demands physical storage space and repeated manual intervention during the cleaning cycle. Moreover, most conventional tools lack the adaptability to simultaneously handle both surface polishing and stain removal within a single integrated apparatus. This inefficiency becomes more pronounced in environments requiring high standards of cleanliness, such as hospitals, schools, and commercial buildings. Furthermore, switching between tools during cleaning operations may result in incomplete coverage or inconsistent results. Existing products often lack an effective means of combining different cleaning agents during use, which limits their effectiveness in removing varied types of floor contaminants. As a result, users continue to seek a comprehensive, ergonomic, and efficient solution that minimizes tool changes and maximizes cleaning performance.

Therefore, there exists a long-felt need in the art for a dual cleaning head device that enables both abrasive scrubbing and fluid absorption in a single integrated device. There also exists a long-felt need in the art for a dual cleaning head device that allows for on-demand spraying and mixing of multiple cleaning solutions. Moreover, there exists a long-felt need in the art for a dual cleaning head device that improves cleaning efficiency while reducing physical strain and equipment redundancy.

The subject matter disclosed and claimed herein, in one embodiment thereof, comprises a dual cleaning head device. The device is comprised of a body having a dual-sided cleaning head assembly, a spray mechanism, and a fluid reservoir system comprising at least two separate containers for cleaning solutions. The containers are mounted either fixedly or removably within the body and fluidly connect to a mixing chamber via a flow initiation port. A selector valve enables users to draw from one container, the other, or a mixture of both, directing the fluid to at least one spray mechanism with a nozzle and flow regulator. The cleaning head assembly is pivotally attached to the body and includes a first side comprising a mop element and a second side comprising a scrubbing element, both of which are removably attached for case of maintenance. The cleaning head may be locked in a fixed orientation using a locking mechanism. The device further comprises at least one trigger to control fluid spray and permits manual rotation of the cleaning head to alternate between mop and scrubbing functions during operation.

In this manner, the dual cleaning head device of the present invention accomplishes all the foregoing objectives and provides a device that integrates an abrasive and absorbent cleaning interface within a single device, thereby eliminating the need for separate equipment. The dual-container reservoir and mixing chamber allow for the application of cleaning solutions, enhancing adaptability for diverse cleaning requirements. The ergonomic design, coupled with telescopic adjustment and manual control over fluid dispensing, addresses both the physical and operational challenges associated with traditional floor-cleaning methods. Through these combined features, the dual cleaning head device provides a consolidated and efficient approach to floor maintenance, addressing longstanding issues of inefficiency, redundancy, and inadequate cleaning coverage.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dual cleaning head device. The floor cleaning device is designed to enhance ergonomic operation, reduce cleaning time, and provide flexible cleaning of various floor surfaces. The device enables application of one or more cleaning solutions directly to a target area and performs surface treatment using a dual-sided cleaning head assembly.

The device is comprised of a body, which may be fixed or telescopic to suit different user heights and environments. In telescopic configurations, the body includes at least one locking member for securing the desired length. The body is further comprised of a handle.

The device includes a solution reservoir comprising at least one, and preferably two, cleaning solution containers. These containers may be fixedly mounted or removably engaged with a receiving area of the body. Each container may include a cap. The receiving area is comprised of a flow initiation port for controlled fluid transfer. The flow initiation port may automatically open upon seating of the container and close when removed to prevent leakage. The port may also incorporate a unidirectional valve to control flow and prevent contamination or backflow. A mixing chamber may be included in the receiving area, configured to receive cleaning solution from the containers. A selector valve adjacent to or integrated within the mixing chamber allows selection of solution from either container or a mixture of both.

Cleaning solution from the reservoir is directed to at least one spray mechanism. In one embodiment, each container is connected to a dedicated spray mechanism actuated by a corresponding trigger. In another configuration, a single spray mechanism may be actuated by a unified trigger. The spray mechanism includes at least one nozzle and a flow regulator, enabling emission in patterns such as fan spray, mist, or pulsed bursts.

The device is also comprised of a cleaning head assembly pivotally attached to a lower end of the body via at least one pivot point. The pivot point may allow bi-directional or multi-axis movement and may include a locking mechanism to fix the orientation during use. The cleaning head assembly includes a cleaning head with a first side comprising a mop element and a second side comprising a scrubbing element. The mop element may be made of absorbent or polishing materials such as microfiber or chamois, while the scrubbing element may use abrasive materials such as polymeric bristles or scouring mesh. Both the mop and scrubbing elements are removably attached to the cleaning head by at least one fastening component.

The method of use includes providing the device with a body, handle, solution reservoir, spray mechanism, and dual-sided cleaning head assembly. Cleaning solutions are added to the containers, and the selector valve is actuated to choose the desired fluid path. A trigger is used to dispense solution through the nozzle, and the cleaning head is engaged with the floor. The mop element is used to absorb or polish, followed by rotation of the cleaning head to expose the scrubbing element for abrasive cleaning. The mop and scrubbing elements are then removed for maintenance.

Accordingly, the dual cleaning head device of the present invention is particularly advantageous as it provides a device that integrates an abrasive and absorbent cleaning interface within a single device, thereby eliminating the need for separate equipment. The dual-container reservoir and mixing chamber allow for the application of cleaning solutions, enhancing adaptability for diverse cleaning requirements. The ergonomic design, coupled with telescopic adjustment and manual control over fluid dispensing, addresses both the physical and operational challenges associated with traditional floor-cleaning methods. Through these combined features, the dual cleaning head device provides a consolidated and efficient approach to floor maintenance, addressing longstanding issues of inefficiency, redundancy, and inadequate cleaning coverage.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a dual cleaning head device of the present invention in accordance with the disclosed architecture;

FIG. 2 illustrates an enhanced perspective view of a cleaning head of one potential embodiment of a dual cleaning head device of the present invention in accordance with the disclosed architecture; and

FIG. 3 illustrates a flowchart of a method of using one potential embodiment of a dual cleaning head device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a dual cleaning head device that enables both abrasive scrubbing and fluid absorption in a single integrated device. There also exists a long-felt need in the art for a dual cleaning head device that allows for on-demand spraying and mixing of multiple cleaning solutions. Moreover, there exists a long-felt need in the art for a dual cleaning head device that improves cleaning efficiency while reducing physical strain and equipment redundancy.

The present invention, in one exemplary embodiment, is comprised of a dual cleaning head device. The floor cleaning device facilitates flexible cleaning across various floor surfaces while promoting ergonomic operation and reducing overall cleaning time. Surface treatment is carried out using a dual-sided cleaning head assembly, which follows the targeted application of one or more cleaning solutions.

A body forms the structural core of the device and may be constructed as either a fixed-length or telescopic unit to accommodate a range of user heights and operating conditions. Telescopic embodiments incorporate at least one locking member to secure the selected extension. A handle is integrated into the body for user manipulation.

The solution reservoir integrated into the device includes at least one, and preferably two, cleaning solution containers. These containers may either be permanently mounted or removably coupled with a receiving area on the body. Each container features a cap to allow the introduction of cleaning solutions. The receiving area is equipped with a flow initiation port that regulates fluid transfer. The port is designed to open automatically when a container is inserted and close upon removal to prevent leakage. Flow control and backflow prevention may be achieved through a unidirectional valve. A mixing chamber may be incorporated within the receiving area to collect solution from the containers, and a selector valve, positioned adjacent to or within the mixing chamber, permits fluid path selection from either container or a combination of both.

Cleaning solution drawn from the reservoir is conveyed to at least one spray mechanism. In one configuration, each container connects to an individual spray mechanism activated by a corresponding trigger. Alternatively, a single spray mechanism may be operated by a unified control trigger. The spray mechanism includes at least one nozzle and a flow regulator, enabling the user to dispense solution in a range of patterns, such as mist, pulsed bursts, or fan spray.

The cleaning head assembly is attached pivotally to the lower end of the body via at least one pivot point, allowing multi-axis or bi-directional movement. A locking mechanism may be incorporated to secure the cleaning head in a fixed orientation during use. The cleaning head includes a first side equipped with a mop element and a second side fitted with a scrubbing element. The mop element may be fabricated from absorbent or polishing materials including microfiber or chamois, while the scrubbing element may include abrasive surfaces such as polymeric bristles or scouring mesh. Both cleaning elements are removably affixed to the cleaning head using at least one fastening component.

A method of use begins with providing the device, including the body, handle, solution reservoir, spray mechanism, and the dual-sided cleaning head assembly. Cleaning solutions are then poured into the containers, and the selector valve is engaged to determine the fluid path. The trigger is then actuated to dispense the solution through the nozzle, following which the cleaning head is applied to the floor. The mop element is used for absorption or polishing, and the cleaning head is subsequently rotated to employ the scrubbing element for abrasive action. Once cleaning is complete, both cleaning elements are removed for maintenance.

Therefore, the device offers notable advantages by integrating both absorbent and abrasive cleaning interfaces into a single unit, thereby removing the need for separate tools. The dual-container reservoir, combined with a mixing chamber, facilitates selective application of cleaning solutions, enhancing the device's adaptability to varied cleaning tasks. Ergonomic design features, including telescopic adjustment and manual fluid control, address operational and physical inefficiencies inherent in conventional cleaning tools. These integrated functionalities result in a streamlined and effective floor maintenance solution, reducing redundancy and improving cleaning coverage.

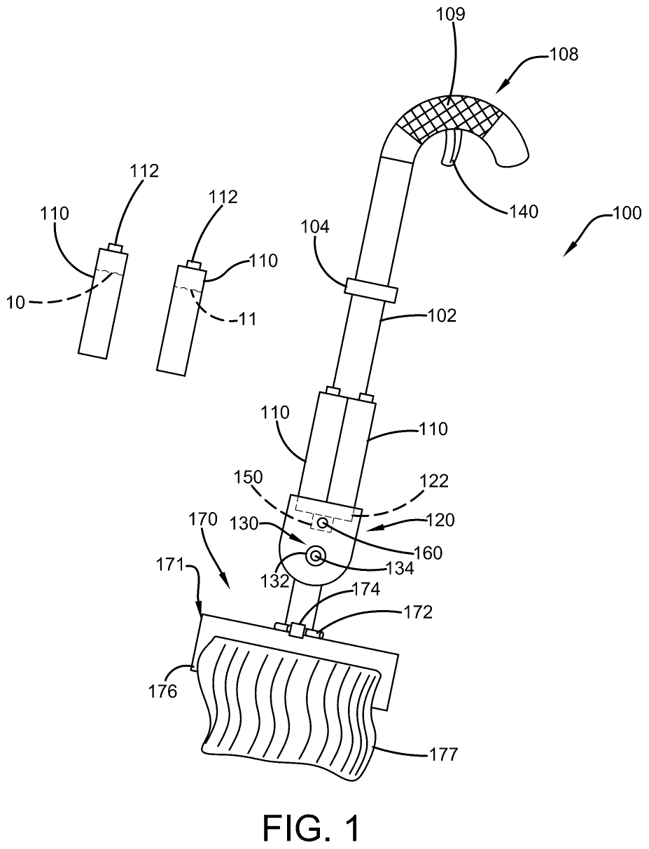

Referring initially to the drawings, FIG. 1 illustrates a perspective view of one potential embodiment of a dual cleaning head device 100 of the present invention in accordance with the disclosed architecture. The floor cleaning device 100 is designed to facilitate efficient, versatile, and user-controlled cleaning of various floor surfaces. The device 100 enables a user to apply one or more cleaning solutions directly to a target area, followed by surface treatment using an integrated dual-sided cleaning head assembly 170. As a result, the device 100 improves ergonomics, reduces cleaning time, and increases the flexibility of surface cleaning operations in both residential and commercial environments.

The device 100 is comprised of a body 102. The body 102 may be of fixed length or may be telescopic to accommodate users of varying height and diverse operating environments. In telescopic embodiments, the body 102 may be comprised of at least one locking member 104 (as seen in FIG. 1) that secures the body 102 to a desired extension length. The locking member 104 may be comprised of mechanisms such as but not limited to a twist-lock collar, a spring-loaded detent pin, or a latch-based clamp. The body 102 may be fabricated from materials such as but not limited to aluminum, stainless steel, reinforced thermoplastics, or carbon fiber composites to provide structural rigidity while minimizing overall weight.

The body 102 is further comprised of a handle 106. The handle 106 may be of any size, shape, and configuration. In one embodiment, the handle 106 is comprised of a grip-enhancing surface layer 108. The grip area 108 may be comprised of materials such as but not limited to rubber, silicone, or thermoplastic elastomers with surface texturing 109. The surface texturing 109 may be comprised of patterns such as but not limited to ribbing, dimples, knurling, or micro-patterned geometries to enhance manual retention during operation.

The device 100 is comprised of a solution reservoir comprising at least one, and preferably two, cleaning solution containers 110, as seen in FIG. 1. In one embodiment, the containers 110 may be fixedly mounted to the body 102 and may be filled via removable caps 112. The caps 112 may be but not limited to screw caps, snap-fit lids, hinged covers, or valve-sealed spouts to allow introduction of cleaning solution 10. In one embodiment, two containers 110 are fixedly attached to one another in a single container unit.

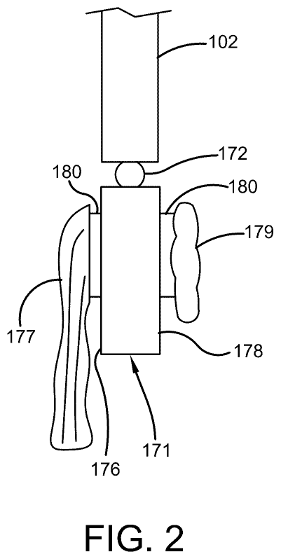

In an alternate embodiment, the containers 110 may be removably engaged with at least one receiving area 120 of the body 102 (as seen in FIG. 2) such that the containers 110 can be detached from the body 102 for refilling or replacement (wherein the caps 112 are also present on the containers 110). The receiving area 120 may be comprised of a flow initiation port 122 for fluid transfer of cleaning solution 10 from the containers 110. The flow initiation port 122 may be comprised of a valve-based coupling system, a puncture-activated membrane, a pressure-sensitive release gate, etc.

In one configuration, the flow initiation port 122 may automatically open when the container 110 is seated in the receiving area 120 and may close when the container 110 is removed, thereby preventing leakage. In another embodiment, the flow initiation port 122 may be comprised of a check valve or diaphragm valve that permits unidirectional flow of the cleaning solution 10, thereby enhancing flow control and preventing backflow or contamination.

In one embodiment, the receiving area 120 may be further comprised of a mixing chamber 150 (as seen in FIG. 1), which receives cleaning solution 10 from the containers 110. A selector valve 160 may be mounted adjacent to or integrated within the mixing chamber 150. The selector valve 160 may allow a user to select a fluid path from a first container 110, a second container 110, or any mixture of both containers 110. This allows two separate cleaning solutions 10,11 to be mixed from two containers 110. The selector valve 160 may be comprised of but is not limited to a rotary dial, push-button control, slide switch, etc.

Cleaning solution 10 exiting the reservoir may further be directed to at least one spray mechanism 130. In one embodiment, each container 110 is fluidly connected to an independent spray mechanism 130, each actuated by a corresponding trigger 140 that is in mechanical linkage. In a different embodiment, a single spray mechanism 130 may be actuated by a unified control trigger 140. The spray mechanism 130 may be comprised of at least one nozzle 134 configured to emit fluid in a spray pattern such as but not limited to fan spray, direct stream, mist, or pulsed bursts. The mechanism 130 may also be comprised of a flow regulator 132, which may be actuated via a rotary dial, linear slide, etc.

The device 100 is also comprised of a cleaning head assembly 170, as seen in FIG. 1 and FIG. 2. The cleaning head assembly 170 may be pivotally attached to a lower end of the body 102 via at least one pivot point 172. The pivot point 172 may be comprised of a hinge, ball-and-socket joint, a cylindrical bushing, etc. that permits bi-directional angular rotation and/or multi-axis articulation. A locking mechanism 174 may allow the pivot point 172 to be locked in a selected orientation during use. The locking mechanism 174 may be comprised of a detent pin, friction lock, cam lever, gear-toothed indexer, etc.

The cleaning head assembly 170 is comprised of a cleaning head 171, which may be symmetrical or asymmetrical, and includes a first side 176 and a second side 178. The first side 176 may be comprised of a mop element 177. The mop element 177 may be comprised of fluid-absorbent or polishing materials such as but not limited to microfiber, cotton, synthetic chamois, or blended textile pads. The second side 178 may be comprised of a scrubbing element 179. The scrubbing element 179 may be comprised of abrasive or friction-inducing surfaces such as but not limited to polymeric bristles, metallic scouring mesh, rubberized ridges, melamine foam segments, high-friction silicone overlays, etc.

The mop element 177 and scrubbing element 179 may each be removably attached to the cleaning head 171 by at least one fastening component 180, as seen in FIG. 2. The fastening component 180 may be comprised of hook-and-loop fasteners, snap buttons, elastic sleeves, sliding tracks, integrated pockets within the elements 177,179, or magnetic interfaces, etc. to permit periodic detachment and cleaning or replacement of the elements 177,179.

In one embodiment, the device 100 is also comprised of the cleaning head assembly 170 and is not comprised of any receiving area 120, containers 110, and other associated structures for said components.

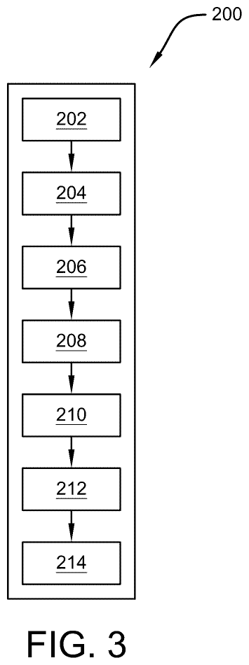

The present invention is also comprised of a method of using 200 the device 100, as seen in FIG. 3. First, a device 100 is provided that may be comprised of a body 102 comprising at least one handle 106, at least one solution reservoir comprising at least one container 110 with a cap 112, at least one receiving area 120, at least one spray mechanism 130 with at least one nozzle 134 and flow regulator 132, at least one trigger 140, and a dual-sided cleaning head assembly 170 comprised of at least one pivot point 172, at least one locking mechanism 174, and a cleaning head 171 with a first side 176 comprised of a mop element 177 and a second side 178 comprised of a scrubbing element 179 [Step 202]. Then, a first container 110 is filled with a first cleaning solution 10 and a second container 110 is filled with a second cleaning solution 11 [Step 204]. Then, the selector valve 160 is actuated to select a desired fluid path from either container 110 or a mixture of both containers 110 [Step 206]. Next, at least one trigger 140 is actuated to initiate fluid flow to the spray mechanism 130, whereby cleaning solution 10,11 (or a mixture of both solutions 10,11) is dispensed through the nozzle 134 in a selected spray pattern [Step 208]. Then, the cleaning head assembly 170 is engaged with the floor surface, and the user may pivot the assembly 170 via the pivot point 172 and optionally lock the orientation using the locking mechanism 174 [Step 210]. Next, the first side 176 of the cleaning head 171 comprising the mop element 177 is used to absorb or polish the treated surface area [Step 212]. Then, the cleaning head 171 is rotated or flipped to expose the second side 178, and the scrubbing element 179 is applied to dislodge debris or perform abrasive cleaning as needed [Step 216]. Finally, the mop element 177 and scrubbing element 179 are removed from the cleaning head 171 via the fastening component 180 for cleaning or replacement [Step 214].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dual cleaning head device” and “device” are interchangeable and refer to the dual cleaning head device 100 of the present invention.

Notwithstanding the foregoing, the dual cleaning head device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the dual cleaning head device 100 as shown in the FIGS. are for illustrative purposes only, and that many other sizes and shapes of the dual cleaning head device 100 are well within the scope of the present disclosure. Although the dimensions of the dual cleaning head device 100 are important design parameters for user convenience, the dual cleaning head device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dual cleaning head device comprising:
a body;
a handle attached to the body;
a first container fixedly attached to the body;
a second container fixedly attached to the body;
a selector valve configured to select a fluid path from the first container, the second container, or a mixture of both the first container and the second container;
a spray mechanism fluidly connected to the solution reservoir and comprising a nozzle;
a trigger mechanically linked to the spray mechanism; and
a dual-sided cleaning head assembly attached to the body comprising:
a cleaning head comprising a first side and a second side,
a mop element attached to the first side, and
a scrubbing element attached to the second side.

2. The dual cleaning head device of claim 1, wherein the spray mechanism is comprised of a flow regulator.

3. The dual cleaning head device of claim 1, wherein the dual-sided cleaning head assembly attaches to the body via a pivot point.

4. The dual cleaning head device of claim 3 further comprised of a locking mechanism.

5. The dual cleaning head device of claim 1, wherein the scrubbing element is comprised of a polymeric bristle, a metallic scouring mesh, a rubberized ridge, a melamine foam segment, or a high-friction silicone overlay.

6. The dual cleaning head device of claim 1, wherein the mop is comprised of a microfiber, a cotton, a synthetic chamois, or a blended textile pads.

7. The dual cleaning head device of claim 1, wherein the mop element attaches to the first side via a first fastener.

8. The dual cleaning head device of claim 1, wherein the mop element attaches to the first side via a second fastener.

9. The dual cleaning head device of claim 1, wherein the handle is comprised of a grip area comprised of a texture.

10. The dual cleaning head device of claim 1, wherein the body is comprised of a telescopic body.

11. The dual cleaning head device of claim 1, wherein the nozzle emits a fan spray pattern, a direct stream pattern, a mist pattern, or a pulsed burst pattern.

12. A dual cleaning head device comprising:
a body;
a handle attached to the body;
a first container removably attached to the body;
a second container removably attached to the body;
a selector valve configured to select a fluid path from the first container, the second container, or a mixture of both the first container and the second container;
a spray mechanism fluidly connected to the solution reservoir and comprising a nozzle;
a trigger mechanically linked to the spray mechanism; and
a dual-sided cleaning head assembly attached to the body comprising:
a cleaning head comprising a first side and a second side,
a mop element attached to the first side, and
a scrubbing element attached to the second side.

13. The dual cleaning head device of claim 12 further comprised of a receiving area that receives the first container and the second container.

14. The dual cleaning head device of claim 12, wherein the flow initiation port is comprised of a check valve.

15. The dual cleaning head device of claim 12, wherein the scrubbing element is comprised of a polymeric bristle, a metallic scouring mesh, a rubberized ridge, a melamine foam segment, or a high-friction silicone overlay.

16. The dual cleaning head device of claim 12, wherein the mop is comprised of a microfiber, a cotton, a synthetic chamois, or a blended textile pads.

17. The dual cleaning head device of claim 12, wherein the mop element attaches to the first side via a first fastener.

18. The dual cleaning head device of claim 12, wherein the mop element attaches to the first side via a second fastener.

19. The dual cleaning head device of claim 12, wherein the handle is comprised of a grip area comprised of a texture.

20. A method of using a dual cleaning head device, the method comprising the following steps:
providing a dual cleaning head device comprised of a body, a first container and a second container, a receiving area, a spray mechanism comprised of a nozzle and a flow regulator, a trigger, and a dual-sided cleaning head assembly that attaches to the body via a pivot point, the dual-sided cleaning head assembly having a first side with a mop element and a second side with a scrubbing element;
filling the first container with a first cleaning solution and the second container with a second cleaning solution;
operating a selector valve to direct the first cleaning solution, the second cleaning solution, or a combination thereof;
actuating the trigger to dispense the first cleaning solution, the second cleaning solution, or a combination thereof through the nozzle;
engaging the cleaning head with a surface and using the mop element to treat the surface; and
flipping the cleaning head to access the scrubbing element and using the scrubbing element for abrasive cleaning of the surface.
